(19) United States
(12) Patent Application Publication
(10) Pub. No.: US 2025/0069117 A1
(43) Pub. Date: Feb. 27, 2025

(54) METHOD AND SYSTEM FOR MANAGING INFORMATION OF INFORMATION PROVIDER BASED ON CONVERSATION WITH INFORMATION PROVIDER

(71) Applicant: NAVER Corporation, Seongnam-si (KR)

(72) Inventors: Min Kyeam KIM, Seongnam-si (KR); Jae Min AHN, Seongnam-si (KR); Seok Won PARK, Seongnam-si (KR); Sungeun KIM, Seongnam-si (KR); SunYoung HA, Seongnam-si (KR); Jisu SEO, Seongnam-si (KR); Jaeman PARK, Seongnam-si (KR); SaeRom PARK, Seongnam-si (KR); Jinseok LIM, Seongnam-si (KR)

(21) Appl. No.: 18/813,452

(22) Filed: Aug. 23, 2024

(30) Foreign Application Priority Data
Aug. 23, 2023 (KR) 10-2023-0110482

(51) Int. Cl. G06Q 30/0251

(52) U.S. Cl. CPC G06Q 30/0256

(57) ABSTRACT

A method and system for managing information of an information provider based on a conversation with an information provider. An information management method may include providing a conversational information management function to an information provider that desires to provide content to a user of a search service; conducting a conversation between large language model (LLM)-based artificial intelligence and the information provider through the conversational information management function; and analyzing the conversation and managing a campaign of the information provider.

### CROSS-REFERENCE TO RELATED APPLICATION(S)

This U.S. non-provisional application claims the benefit of priority under 35 U.S.C. § 119 to Korean Patent Application No. 10-2023-0110482 filed on Aug. 23, 2023, in the Korean Intellectual Property Office (KIPO), the entire contents of which are incorporated herein by reference.

### BACKGROUND OF THE INVENTION

One or more example embodiments of the present invention in the following description relate to a method and system for managing information of an information provider based on a conversation with the information provider.

Large language models (LLM) are a type of artificial intelligence program trained with a large corpus of text data to create a human-like response to a natural language input, and are also a language model with an artificial neural network containing numerous parameters (usually billions of weights or more). LLMs may be trained with a significant amount of unlabeled text using self-supervised learning or semi-self-supervised learning.

Reference material includes Korean Patent Registration No. 10-2551531.

### BRIEF SUMMARY OF THE INVENTION

One or more example embodiments of the present invention provide a method and system for managing information of an information provider based on a conversation with the information provider.

According to an aspect of at least one example embodiment of the present invention, there is provided an information management method of a computer device including at least one processor, the information management method including providing, by the at least one processor, a conversational information management function to an information provider that desires to provide content to a user of a search service; conducting, by the at least one processor, a conversation between large language model (LLM)-based artificial intelligence and the information provider through the conversational information management function; and analyzing, by the at least one processor, the conversation and managing a campaign of the information provider.

According to an aspect of the present invention, the providing of the conversational information management function may include providing a function for registering a campaign-specific asset of the information provider through the conversational information management function.

According to another aspect of the invention, the conducting of the conversation may include creating conversation contents to be provided to the information provider using at least two of the campaign of the information provider, a campaign-specific asset of the information provider, a campaign-specific prompt of the information provider, information collected from outside, and contents of the conversation through the artificial intelligence.

According to still another aspect of the invention, the asset may include at least one of a uniform resource locator (URL) related to the content that the information provider desires to provide, a title of the content, an identifier of the content, a category of the content, a multimedia related to the content, contents of the content, and contents of an article related to the content.

According to still another aspect of the invention, the prompt may include at least one of a phrase entered to be emphasized in relation to the content that the information provider desires to provide, a keyword entered to be emphasized in relation to the content that the information provider desires to provide, a tone of an information message to be included in the content, and a format of the information message.

According to still another aspect of the invention, the campaign may be created for each purpose for which the information provider desires to provide the content and may include an asset and a prompt for dynamically creating the content of corresponding purpose at a search point in time.

According to still another aspect of the invention, the managing of the campaign may include creating a new campaign using at least one of an asset included in a previously created campaign of the information provider and information collected from outside in relation to the information provider.

According to still another aspect of the invention, the managing of the campaign may include modifying a prompt of the information provider registered to a previously created campaign of the information provider based on contents of the conversation.

According to still another aspect of the invention, the managing of the campaign may include registering a new prompt to a previously created campaign of the information provider based on contents of the conversation.

According to still another aspect of the invention, the content to be provided to the user through the search service may be dynamically created at a search point in time of the user using an asset and a prompt of the information provider registered to a corresponding campaign and included in search results.

According to at least one example embodiment of the present invention, there is provided a non-transitory computer-readable recording medium storing a computer program to execute the method on the computer device.

According to at least one example embodiment of the invention, there is provided a computer device including at least one processor configured to execute instructions readable on the computer device, wherein the at least one processor is configured to provide a conversational information management function to an information provider that desires to provide content to a user of a search service, to conduct a conversation between large language model (LLM)-based artificial intelligence and the information provider through the conversational information management function, and to analyze the conversation and manage a campaign of the information provider.

According to some example embodiments of the invention, it is possible to provide a method and system for managing information of an information provider based on a conversation with the information provider.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating an example of a network environment according to at least one example embodiment of the present invention;

FIG. 2 is a block diagram illustrating an example of a computer device according to at least one example embodiment of the present invention;

FIG. 3 is a block diagram illustrating an example of an information management system according to at least one example embodiment of the present invention;

FIG. 4 is a flowchart illustrating an example of an information management method according to at least one example embodiment of the present invention;

FIGS. 5 to 10 illustrate examples of a conversational information management center according to at least one example embodiment of the present invention;

FIG. 11 illustrates an example of describing a process of providing an answer to a prompt of a user according to at least one example embodiment of the present invention; and

FIG. 12 illustrates an example of providing search results according to at least one example embodiment of the present invention.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, some example embodiments will be described with reference to the accompanying drawings.

An information management system according to the example embodiments may be implemented by at least one computer device. Here, a computer program according to an example embodiment may be installed and executed on the computer device that implements the information management system, and the computer device may perform an information management method according to the example embodiments under control of the executed computer program. The aforementioned computer program may be stored in a computer-readable storage medium to computer-implement the information management method in conjunction with the computer device.

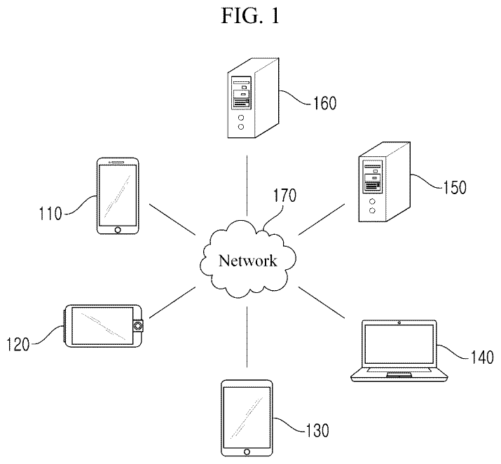

FIG. 1 illustrates an example of a network environment according to at least one example embodiment. Referring to FIG. 1, the network environment may include a plurality of electronic devices 110, 120, 130, and 140; a plurality of servers 150 and 160; and a network 170. FIG. 1 is provided as an example only. The number of electronic devices or the number of servers is not limited thereto.

Each of the plurality of electronic devices 110, 120, 130, and 140 may be a fixed terminal or a mobile terminal that is configured as a computer system. For example, the plurality of electronic devices 110, 120, 130, and 140 may each comprise a smartphone, a mobile phone, a navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, an augmented reality (AR) device, or the like. For example, although FIG. 1 illustrates a shape of a smartphone as an example of the electronic device 110, the electronic device 110 used herein may refer to any one of various types of physical computer systems capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 170. For example, the network 170 may include at least one of a plurality of network topologies that include a personal area network (PAN), a local area network (LAN), a campus area network (CAN), a metropolitan area network (MAN), a wide area network (WAN), a broadband network (BBN), and the Internet. Also, the network 170 may include at least one of a plurality of network topologies that include a bus network, a star network, a ring network, a mesh network, a star-bus network, a tree or hierarchical network, and the like. However, these network topologies are provided as examples only.

Each of the servers 150 and 160 may be configured as a computer device or a plurality of computer devices that provides an instruction, a code, a file, content, a service, etc., through communication with the plurality of electronic devices 110, 120, 130, and 140 over the network 170. For example, the server 150 may be a system that provides a first service to the plurality of electronic devices 110, 120, 130, and 140 connected over the network 170, and the server 160 may also be a system that provides a second service to the plurality of electronic devices 110, 120, 130, and 140. As a detailed example, the server 150 may provide a service (e.g., a search service) targeted by a corresponding application to the plurality of electronic devices 110, 120, 130, and 140 as the first service through the application as the computer program installed and executed on the plurality of electronic devices 110, 120, 130, and 140. As another example, the server 160 may provide a service for distributing a file for installing and executing the aforementioned application to the plurality of electronic devices 110, 120, 130, and 140 as the second service.

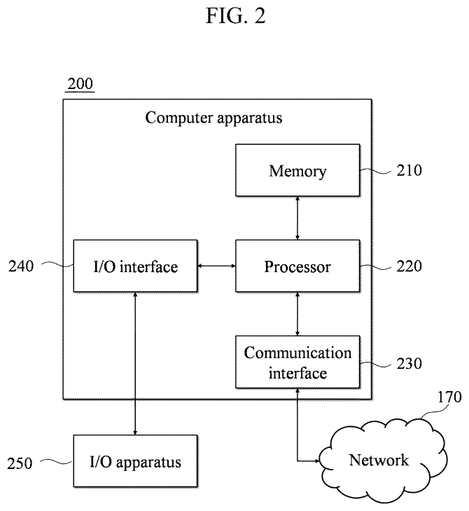

FIG. 2 is a block diagram illustrating an example of a computer device according to at least one example embodiment. Each of the plurality of electronic devices 110, 120, 130, and 140 of FIG. 1 or each of the servers 150 and 160 may be implemented by a computer device or apparatus 200 of FIG. 2.

Referring to FIG. 2, the computer device 200 may include a memory 210, a processor 220, a communication interface 230, and an input/output (I/O) interface 240. The memory 210 may include a permanent mass storage device, such as a random access memory (RAM), a read only memory (ROM), and a disk drive, as a non-transitory computer-readable recording medium. The permanent mass storage device, such as ROM and a disk drive, may be included in the computer device 200 as a permanent storage device separate from the memory 210. Also, an OS (operating system) and at least one program code may be stored in the memory 210. Such software components may be loaded to the memory 210 from another non-transitory computer-readable recording medium that is separate from the memory 210. The other non-transitory computer-readable recording medium may include a non-transitory computer-readable recording medium, for example, a floppy drive, a disk, a tape, a DVD/CD-ROM drive, a memory card, etc. According to other example embodiments, software components may be loaded to the memory 210 through the communication interface 230, instead of through the non-transitory computer-readable recording medium. For example, the software components may be loaded to the memory 210 of the computer device 200 based on a computer program installed via files received over the network 170.

The processor 220 may be configured to process instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as in the memory 210.

The communication interface 230 may provide a function for communication between the computer device 200 and another apparatus, for example, the aforementioned storage devices. For example, the processor 220 of the computer device 200 may forward a request or an instruction created based on a program code stored in the storage device such as the memory 210, data, and a file, to other apparatuses over the network 170 under control of the communication interface 230. Inversely, a signal, an instruction, data, a file, etc., from another apparatus may be received at the computer device 200 through the communication interface 230 of the computer device 200. For example, a signal, an instruction, data, etc., received through the communication interface 230 may be forwarded to the processor 220 or the memory 210, and a file, etc., may be stored in a storage medium, for example, the permanent storage device, further includable in the computer device 200.

The I/O interface 240 may be a device used for interfacing with an I/O device 250. For example, an input device may include a device, such as a microphone, a keyboard, a mouse, etc., and an output device may include a device, such as a display, a speaker, etc. As another example, the I/O interface 240 may be a device for interfacing with an apparatus in which an input function and an output function are integrated into a single function, such as a touchscreen. The I/O device 250 may be configured as a single apparatus with the computer device 200.

According to other example embodiments, the computer device 200 may include a number of components that is greater than or less than the number of components shown in FIG. 2. However, there is no need to clearly illustrate many components according to the related art, as such components are known to those of ordinary skill in the art. For example, the computer device 200 may include at least a portion of the I/O device 250, or may further include other components, for example, a transceiver, a database, etc.

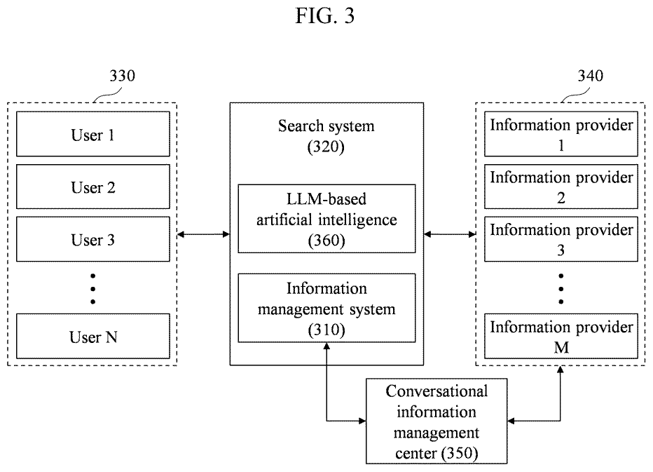

FIG. 3 illustrates an example of an information management system according to at least one example embodiment. FIG. 3 illustrates an information management system 310, a search system 320, a plurality of users 330, a plurality of information providers 340, and a conversational information management center 350.

The search system 320 may correspond to a server (e.g., server 150) that provides a search service to the plurality of users 330, and may be implemented as at least one computer device 200 (FIG. 2). Here, each of the plurality of users 330 may be a physical device of a user that connects to the search system 320 using the network 170 (FIG. 2) to receive the search service. Each of the plurality of information providers 340 may be a physical device of an information provider that registers, to the information management system 310, information the corresponding information provider desires to provide. Here, the physical device may be implemented as the aforementioned computer device 200 (FIG. 2).

The information management system 310 according to the example embodiment may be included in the search system 320, or it may be implemented to interact with the search system 320 through the network 170. The example embodiment of FIG. 3 illustrates an example in which the information management system 310 is included in the search system 320. In this case, the information management system 310 may be implemented on at least one physical device to implement the search system 320. In certain example embodiments, the information management system 310 may be implemented as a physical device that is separate from a physical device that implements the search system 320, and may also be implemented to communicate with the search system 320 through the network 170.

A search service provided by the search system 320 to the plurality of users 330 may include search results corresponding to the input of a user. Search results may be basically created based on information that may be searched on the web. Also, the search system 320 may include, in the search results, information provided from the plurality of information providers 340 that have been provided to the search service. Here, information provided from the plurality of information providers 340 may be advertising information, but it is not limited thereto. The basics of a search service that provides search results is already known and thus, a further description is omitted.

The search system 320 according to the example embodiment may provide the search service by including, in the search results, answers based on artificial intelligence such as a large language model (LLM). For example, the search system 320 may include an LLM-based artificial intelligence module 360 that performs various processing based on an LLM loaded into a memory of the search system 320 (for example, a memory 210 of a computer device 200 implementing the search system 320). The search system 320 may receive a natural language-based prompt from a specific user from among the plurality of users 330. In this case, the search system 320 may input the received prompt into the LLM, may create a first answer suitable for the prompt as LLM results, and may provide search results including the first answer to the user using the LLM-based artificial intelligence module 360. Here, the search results may include at least a portion of various search results in addition to the first answer. Also, the search system 320 may provide the search service through conversation between the LLM-based artificial intelligence module 360 and the user. The search service may be provided to the user while switching between a first mode of providing the first answer as LLM results through a general search service and a second mode of providing the first answer as LLM results through conversation between the LLM-based artificial intelligence module 360 and the user. Here, in each of the first mode and the second mode, an instance for content of an information provider may be further provided to at least a portion of the first answer as a second answer. Here, the term “instance” may mean that instances of different structures or contents may be created and provided to users with respect to the same content of the information provider.

Also, the search results may include the second answer created by at least a portion of the information registered by the plurality of information providers 340. For example, the search system 320 may dynamically create the second answer based on artificial intelligence in which a message of an information provider selected from among the plurality of information providers 340 is projected. In this case, the search system 320 may provide the user with search results that include not only the first answer created using the LLM, but also the second answer based on artificial intelligence.

Here, in creating the second answer based on artificial intelligence, the search system 320 may dynamically create the artificial intelligence-based second answer using any or all of the following: a prompt of the user, the first answer created using the LLM, an asset registered by the information provider and/or a prompt registered by the information provider, instead of merely providing information provided from the information provider as is. Here, the asset may include, for example, a uniform resource locator (URL) related to first information that the information provider desires to provide, a title or an identifier of the first information, a category of the first information, contents of the first information, and contents of an article related to the first information. For example, when the information provider is advertising a specific product or service, the asset may include a URL related to the product or the service, a product name or a service name, a category of the product or the service, product information or service information, and contents of an article related to the product or the service. Also, the prompt registered by the information provider may include information on a phrase or a keyword that the information provider desires to emphasize in relation to the first information and a tone or a format of an information message to be provided as the second answer. As such, the search system 320 may dynamically create the second answer that considers the registered asset and prompt of the information provider desiring to provide its information, and the first answer, as well as the first answer created using the LLM for a natural language prompt of the user. Also, in certain example embodiments, the search system 320 may create the second answer by further using information about the user. Here, information about the user may include the user's demographic information, things of interest, and purchase information, and such information may be used to customize the second answer to the specific user.

In addition, since the plurality of information providers 340 that desire to expose their own information may be present, the search system 320 may dynamically determine to create a second answer using a prompt and an asset of one information provider from among the plurality of information providers 340. For example, the search system 320 may primarily select information providers related to the first answer, that is, the LLM results, based on the first answer among the plurality of information providers 340. That is, in primarily selecting the information providers, the search system 320 may use at least one of the prompt of the user, the LLM results, and a recommendation query created by the LLM. For example, the recommendation query may include recommendation prompts that the LLM-based artificial intelligence module 360 can be used as input to the LLM. Then, the search system 320 may dynamically conduct an auction between the primarily selected information providers and may select a first information provider as an information provider for creating the second answer. Any known method for the auction may be used. For example, a generalized second price (GSP) auction method may be used.

As described above, in providing an answer to a natural language-based prompt from the user, the search system 320 may dynamically create an artificial intelligence-based second answer to which an answer that has been dynamically created based on the prompt and the asset of the information provider (i.e., a message of the information provider) is projected. Therefore, the search system 320 may provide the user with the dynamically created answer such that the message of the information provider is projected in relation to the natural language-based prompt received from the user.

The information management system 310 may provide the conversational information management center 350 for managing information for creating content that each of the plurality of information providers 340 desires to provide to the plurality of users 330 through the search service. The conversational information management center 350 may be produced in the form of, for example, a webpage that is provided to the information provider, but it is not limited thereto.

The information management system 310 may interact in a conversational format with the information provider connected via the conversational information management center 350 over the network 170, and may manage information for creating content that the corresponding information provider desires to provide through the search system 320. For example, the information provider may create a campaign for each purpose that the information provider provides the content through conversation with artificial intelligence (from an artificial intelligence (AI) module) provided through the conversational information management center 350, and the aforementioned asset and prompt may be registered for each campaign. For example, the information provider may create a campaign for each of a plurality of various purposes desired by the information provider, such as creating a campaign related to a specific event or creating a campaign related to downloading a specific app. An asset and a prompt related to each campaign may be registered for each campaign. To this end, the conversational information management center 350 may provide a function that allows the information provider to upload a list of campaigns created for the information provider and an asset for each campaign. Meanwhile, the prompt of the information provider may be automatically registered by analyzing the conversation between artificial intelligence (the AI module) and the information provider through the conversational information management center 350.

For example, the information management system 310 may manage a campaign of the information provider, such as to improve an existing campaign or to create a new campaign, through interaction in a conversational format with the information provider using artificial intelligence through the conversational information management center 350. Here, the artificial intelligence may include conversational artificial intelligence based on LLMs. The conversational artificial intelligence may access information that is collectable from outside the system (such as from the internet), such as a campaign pre-registered for the information provider, an asset and a prompt for each campaign, and Internet information, and may process a conversation with the information provider based on the accessed information and contents of a conversation exchanged with the information provider through a current conversation session.

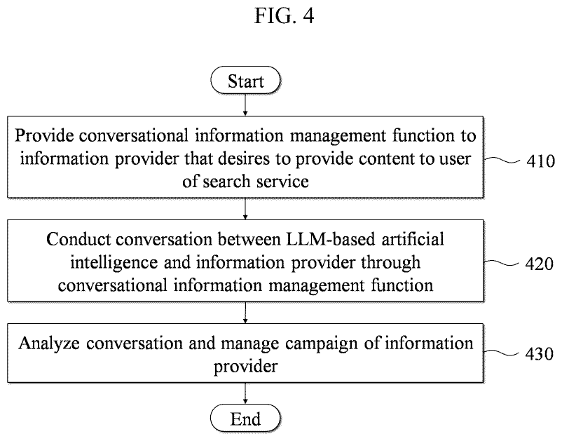

FIG. 4 is a flowchart illustrating an example of an information management method according to at least one example embodiment. The information management method according to the example embodiment may be performed by the computer device 200 that implements the aforementioned information management system 310. Here, the processor 220 of the computer device 200 may be implemented to execute a control instruction according to a code of at least one computer program or a code of an OS included in the memory 210. Here, the processor 220 may control the computer device 200 to perform operations 410 to 430 included in the information management method of FIG. 4.

In operation 410, the computer device 200 may provide a conversational information management function to an information provider that desires to provide content to a user of a search service. Here, the conversational information management function may correspond to the conversational information management center 350 described above with reference to FIG. 3. Here, the computer device 200 may provide a function for registering an asset for each campaign of the information provider through the conversational information management function. This function may include a function that allows the information provider to select a specific campaign and to upload assets related to various formats to the information management system 310.

In operation 420, the computer device 200 may conduct a conversation between LLM-based artificial intelligence module 360 and the information provider through the conversational information management function. For example, the computer device 200 may create conversation contents to be provided to the information provider using at least two of the campaign of the information provider, a campaign-specific asset of the information provider, a campaign-specific prompt of the information provider, information collected from outside the system (such as from the internet), and contents of the conversation through the artificial intelligence. Here, the campaign may be created for each purpose for which the information provider desires to provide content and includes an asset and a prompt for dynamically creating the content of a corresponding purpose at a search point in time. Here, the asset may include at least one of a URL related to the content that the information provider desires to provide, a title of the content, an identifier of the content, a category of the content, multimedia related to the content, contents of the content, and contents of an article related to the content. Here, the multimedia related to the content may include an image and a video related to the content. Also, the prompt may include at least one of a phrase entered to be emphasized in relation to the content that the information provider desires to provide, a keyword entered to be emphasized in relation to the content that the information provider desires to provide, the tone of an information message to be included in the content, and the format of the information message.

In operation 430, the computer device 200 may analyze the conversation and manage a campaign of the information provider. For example, the computer device 200 may create a new campaign using at least one of an asset included in a previously created campaign of the information provider and information collected from outside of the system (such as from the internet) in relation to the information provider. As another example, the computer device 200 may modify a prompt of the information provider registered to a previously created campaign of the information provider based on the contents of the conversation. As another example, the computer device 200 may register a new prompt to a previously created campaign of the information provider based on the contents of the conversation.

The content to be provided to the user through the search service may be dynamically created at a search point in time of the user using an asset and a prompt of the information provider registered to a corresponding campaign and included in search results.

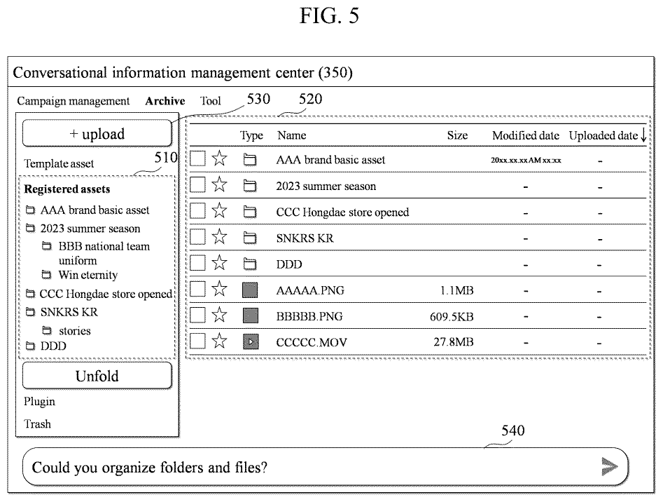

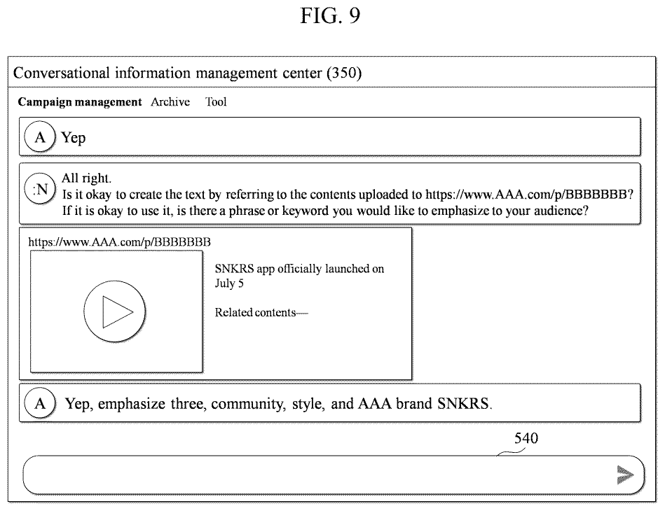

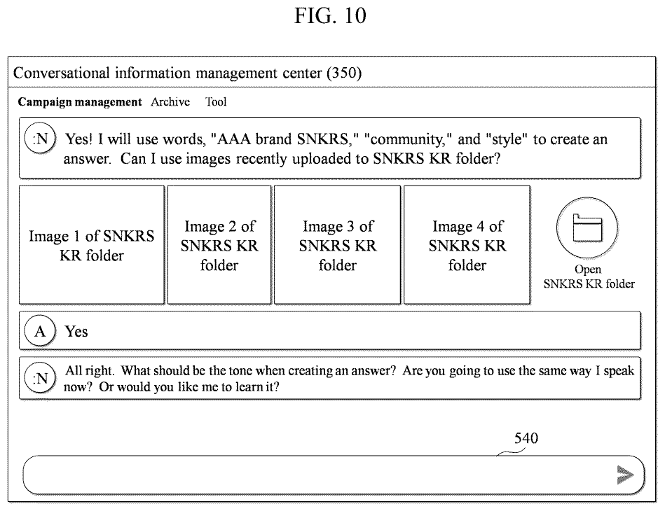

FIGS. 5 to 10 illustrate examples of a conversational information management center according to at least one example embodiment.

FIG. 5 shows an example of a function of the conversational information management center 350 that allows an information provider to register an asset and to manage the registered asset. An upper level folder of assets may correspond to a campaign, and each upper level folder may include a subfolder. A first box 510 (indicated with dotted lines) represents a list of folders for registered assets and a second box 520 (indicated with dotted lines) represents a list of folders for registered assets and files as assets. The information provider may verify or delete a registered asset using the function shown in FIG. 5, and may register a new asset through an “upload” button 530. Here, the function shown in FIG. 5 may include a user interface 540 for delivering a prompt to artificial intelligence (the AI module) and a conversation with the artificial intelligence (the AI module) may be conducted through the user interface 540. The example embodiment of FIG. 5 shows an example in which the information provider requests the artificial intelligence (the AI module) to organize folders and files. As such, the information management system 310 may provide various functions for managing information of the information provider, such as arranging folders and files related to assets of the information provider based on the conversation between the artificial intelligence (the AI module) of the conversational information management center 350 and the information provider.

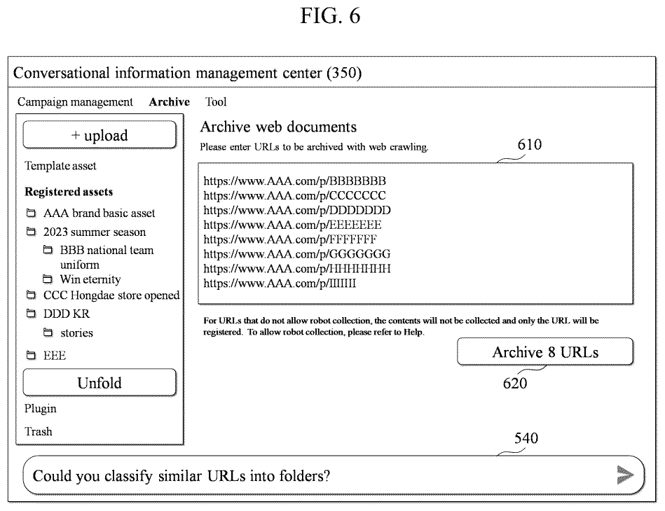

FIG. 6 shows an example of a function of the conversational information management center 350 of receiving a URL as an asset from an information provider, and crawling and collecting content corresponding to the URL with a robot. For example, a first area 610 of FIG. 6 shows an example of URLs entered by the information provider. Here, when the information provider selects a button 620 for archiving, information corresponding to the URLs may be collected by conducting crawling using the robot for each of the entered URLs. FIG. 6 also shows an example of displaying information on the number of URLs entered by the information provider on the button 620. URLs and information collected through the URLs may be managed as assets of the information provider. The example embodiment of FIG. 6 shows an example in which the information provider requests artificial intelligence (the AI module) to classify URLs through the user interface 540. As such, the information management system 310 may provide various functions for managing information of the information provider, such as classifying the URLs entered by the information provider into folders with similar URLs based on the conversation between the artificial intelligence (AI module) of the conversational information management center 350 and the information provider.

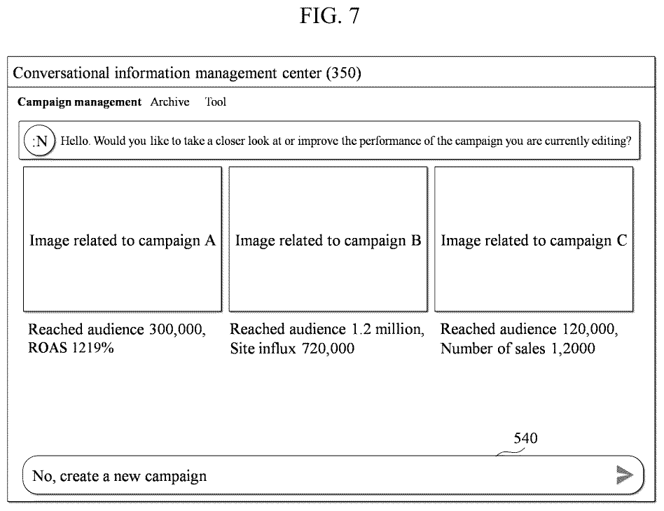

FIG. 7 shows an example in which artificial intelligence (the AI module) first delivers a proposal to an information provider. That is, the artificial intelligence (AI module) of the conversational information management center 350 may also first deliver a proposal related to management of campaigns to the information provider without simply providing an answer to a prompt of the information provider. This proposal may be created based on the information provider's existing campaign and an asset and/or prompt registered to the campaign. The example embodiment of FIG. 7 shows an example in which the information provider rejects the proposal of the artificial intelligence (AI module) and requests creation of a new campaign.

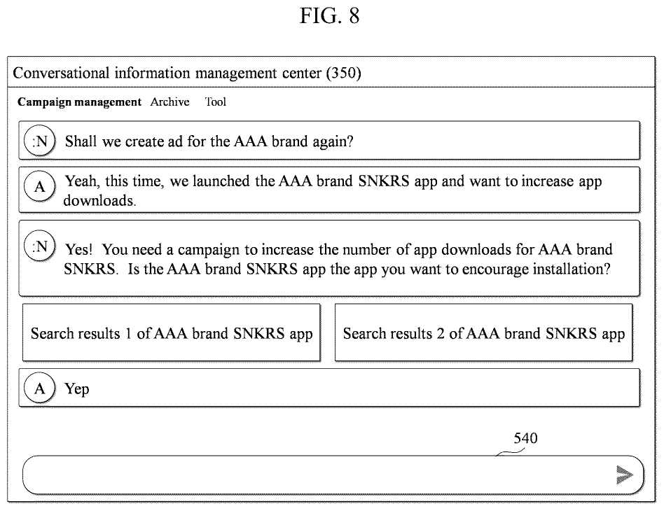

FIGS. 8 to 10 illustrate examples of a process in which artificial intelligence (an AI module) creates a new campaign through a conversation with an information provider. The information management system 310 may create conversation contents to be provided to the information provider using information (search results of AAA brand SNKRS app) collected from outside (e.g., Internet) by the artificial intelligence (AI module) in relation to a prompt of the information provider or using an asset (information collected through asset in a URL format, images of a specific asset folder) previously registered by the information provider. Also, the information management system 310 may acquire and register a prompt of the information provider in relation to a phrase or a keyword (e.g., “AAA brand SNKRS,” “community,” “style”) to be emphasized and/or a tone when creating an answer (e.g., content of the information provider provided to the user through the search service).

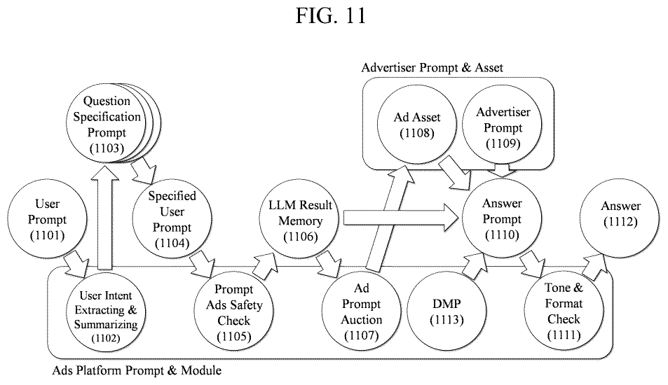

FIG. 11 illustrates an example of describing a process of providing an answer to a prompt from a user according to at least one example embodiment. The example embodiment of FIG. 11 shows an example of a case in which information providers desire to expose advertising for products or services of advertisers as content they desire to provide.

The search system 320 may receive a user prompt 1101 from a terminal of a user connected through the network 170. For example, a prompt may correspond to a natural language-based search term entered by the user. The user may enter a search term through a user interface of a search service provided through the terminal of the user, and the search system 320 may receive the search term entered through the user interface as the user prompt 1101.

Here, the search system 320 may extract a prompt to be actually used for analyzing the user prompt 1101 and by extracting and summarizing user intent through a process of user intent extracting & summarizing 1102.

The search system 320 may induce the user to provide sufficient information for providing an answer in which a marketing message of an advertiser is reflected. For example, the contents of the user prompt 1101 may be insufficient to match with a marketing message of a specific advertiser. In this case, the search system 320 may create a question for inducing additional information for selection of the specific advertiser, and may provide the created question to the user. Then, when a user's answer to the question is received, the prompt may be supplemented using the contents of the received answer. A question specification prompt 1103 may include the prompt acquired through the answer of the user.

Here, the search system 320 may select a specified user prompt 1104 as a prompt for providing the marketing message. That is, the specified user prompt 1104 may be specified based on the prompt acquired through the user intent extracting & summarizing 1102 for the user prompt 1101 and the question specification prompt 1103.

A prompt ads safety check 1105 may be an example of a process of verifying whether the specified user prompt 1104 is a prompt that may expose the marketing message of the advertiser to the user. For example, the search system 320 may create and provide an answer when the specified user prompt 1104 is not a prompt that requests preset illegal information or preset non-advertising information.

Also, the search system 320 may create LLM results by inputting the specified user prompt 1104 into an LLM. FIG. 11 shows an example of an LLM result memory 1106 that stores the LLM results.

The search system 320 may primarily select advertisers related to the LLM results based on the LLM results stored in the LLM result memory 1106. Here, the advertisers related to the LLM results may be advertisers that register marketing messages exposable along with the LLM results. The market messages exposable along with the LLM results may be selected based on relevance between information registered by the advertisers and the LLM results. Also, in certain example embodiments, the search system 320 may use at least one of the specified user prompt 1104, the LLM results, and a recommendation query created by the LLM when primarily selecting the advertisers. In this case, the search system 320 may primarily select the advertisers based on relevance between at least one of the specified user prompt 1104, the LLM results, and the recommendation query and information registered by at least one advertiser. Here, the search system 320 may select a specific advertiser from among the primarily selected advertisers through an ad prompt auction 1107.

When the advertiser is selected, the search system 320 may acquire an ad asset 1108 registered by the selected advertiser and an advertiser prompt 1109 registered by the selected advertiser. Here, the ad asset 1108 and the advertiser prompt 1109 may correspond to an asset and a prompt registered through the conversational information management center 350 for a specific campaign, respectively. In this case, the search system 320 may create an answer prompt 1110 to which the marketing message of the advertiser is reflected using at least one of the user prompt 1101 and the LLM results stored in the LLM result memory 1106 and at least one of the ad asset 1108 and the advertiser prompt 1109. In certain example embodiments, the advertiser may desire to provide an answer in a specific format according to the characteristics of the user. To this end, the search system 320 may create the answer prompt 1110 by further reflecting information on the user. For example, information on the user may include at least one of the user's demographics, things of interest, and purchase information. For example, the search system 320 may analyze the advertiser prompt 1109 and may verify that the advertiser desires to provide a more detailed answer to a female user than to a male user. In this case, the search system 320 may identify the gender of the user through the user's demographic information, and may create the answer prompt 1110 in consideration of the identified gender of the user.

Once the answer prompt 1110 is created, the search system 320 may verify whether the created answer prompt 1110 is suitable for the tone and/or the format that has been verified through the advertiser prompt 1109, that is, the system may perform a tone & format check 1111. If the created answer prompt 1110 does not match the tone and/or the format desired by the advertiser, the answer prompt 1110 may be further processed to be suitable for the tone and/or the format desired by the advertiser. Also, in certain example embodiments, the search system 320 may additionally verify whether the created answer prompt 1110 is safe to be exposed to the particular user.

Then, the search system 320 may add a finally created answer 1112 to the search results and may provide the same to the user through the search service. Also, in certain example embodiments, user information (e.g., gender, age, things of interest, etc.) stored in a data management platform (DMP) may be further used to create the answer prompt 1110. By using this user information, the search system 320 may create the answer 1112 optimized for the user.

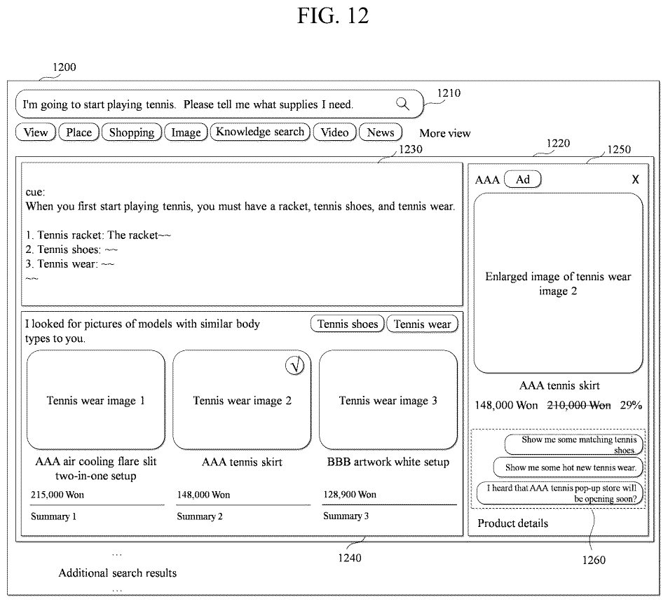

FIG. 12 illustrates an example of providing search results according to at least one example embodiment. FIG. 12 shows an example of a screen of a search page 1200 provided to a user through a search service. The search page 1200 may include a user interface 1210 for receiving input of a prompt of the user. Also, the search page 1200 may include a search result area 1220 for displaying search results. Here, the search result area 1220 may include an LLM result area 1230 for displaying the LLM results created based on an LLM for the prompt of the user.

Also, the search result area 1220 shows an example of an answer area 1240 for displaying an answer created by the search system 320 from the prompt of the user. The example embodiment represents an example in which a plurality of answers are displayed through the answer area 1240. As such, a plurality of answers may be created and displayed for a single prompt. Also, answers for each of two or more information providers may be created and displayed. To this end, the search system 320 may select two or more information providers.

The example embodiment of FIG. 12 shows an example in which an answer of the information provider selected based on the prompt of the user entered into the user interface 1210 and/or LLM results displayed in the LLM result area 1230 is displayed through an extended area 1250. For example, the answer of the information provider selected based on at least one of the prompt of the user, the LLM results, and a recommendation query created by an LLM may be further displayed in the extended area 1250. If the information provider is an advertiser, an ad of the advertiser selected based on the prompt of the user, the LLM results, and the recommendation query created by the LLM may be further displayed in the extended area 1250.

Also, questions as prompts for requesting an additional prompt from the user in relation to the answer displayed in the extended area 1250 may be displayed in a box 1260 (indicated with dotted lines). When the user selects a specific question, the corresponding question is recognized as the additional prompt of the user. In the case of providing a conversational search service, the additional prompt of the user may be recognized as a subsequent conversation of the user. In this case, the search system 320 may create LLM results and/or answer in consideration of the entire conversation with the user.

As described above, according to the example embodiments, there may be provided a method and system for managing information of an information provider based on conversation with the information provider.

The systems or apparatuses described herein may be implemented using hardware components, or a combination of hardware components and software components. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. A processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combinations thereof, for independently or collectively instructing or configuring the processing device to operate as desired. Software and/or data may be embodied in any type of machine, component, physical equipment, virtual equipment, or a computer storage medium or device to provide instructions or data to or to be interpreted by the processing device. The software also may be distributed over network coupled computer systems so that the software is stored and executed in a distributed fashion. The software and data may be stored by one or more computer readable storage mediums.

The methods according to the example embodiments may be implemented in the form of program instructions executable through various computer methods and recorded in non-transitory computer-readable media. The media may include, alone or in combination with program instructions, data files, and data structures. Here, the media may continuously store computer-executable programs or may transitorily store the same for execution or download. Also, the media may be various types of recording devices or storage devices in a form in which one or a plurality of hardware components are combined. Without being limited to media directly connected to a computer system, the media may be distributed over the network. Examples of non-transitory computer-readable media include magnetic media such as hard disks, floppy disks, and magnetic tapes; optical media such as CD ROM disks and DVD; magneto-optical media such as floptical disks; and hardware devices that are specially to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software. Examples of a program instruction include an advanced language code executable by a computer using an interpreter as well as a machine language code produced by a compiler.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An information management method of a computer device comprising at least one processor, the information management method comprising:
providing, by the at least one processor, a conversational information management function to an information provider that desires to provide content to a user of a search service;
conducting, by the at least one processor, a conversation between large language model (LLM)-based artificial intelligence and the information provider through the conversational information management function; and
analyzing, by the at least one processor, the conversation and managing a campaign of the information provider.

2. The information management method of claim 1, wherein the providing of the conversational information management function comprises providing a function for registering a campaign-specific asset of the information provider through the conversational information management function.

3. The information management method of claim 1, wherein the conducting of the conversation comprises creating conversation contents to be provided to the information provider using at least two of the campaign of the information provider, a campaign-specific asset of the information provider, a campaign-specific prompt of the information provider, information collected from outside, and contents of the conversation through the artificial intelligence.

4. The information management method of claim 3, wherein the asset includes at least one of a uniform resource locator (URL) related to the content that the information provider desires to provide, a title of the content, an identifier of the content, a category of the content, a multimedia related to the content, contents of the content, and contents of an article related to the content.

5. The information management method of claim 3, wherein the prompt includes at least one of a phrase entered to be emphasized in relation to the content that the information provider desires to provide, a keyword entered to be emphasized in relation to the content that the information provider desires to provide, a tone of an information message to be included in the content, and a format of the information message.

6. The information management method of claim 1, wherein the campaign is created for each purpose for which the information provider desires to provide the content and includes an asset and a prompt for dynamically creating the content of corresponding purpose at a search point in time.

7. The information management method of claim 1, wherein the managing of the campaign comprises creating a new campaign using at least one of an asset included in a previously created campaign of the information provider and information collected from outside in relation to the information provider.

8. The information management method of claim 1, wherein the managing of the campaign comprises modifying a prompt of the information provider registered to a previously created campaign of the information provider based on contents of the conversation.

9. The information management method of claim 1, wherein the managing of the campaign comprises registering a new prompt to a previously created campaign of the information provider based on contents of the conversation.

10. The information management method of claim 1, wherein the content to be provided to the user through the search service is dynamically created at a search point in time of the user using an asset and a prompt of the information provider registered to a corresponding campaign and included in search results.

11. A non-transitory computer-readable recording medium storing a computer program to execute the method of claim 1 on the computer device.

12. A computer device comprising at least one processor configured to execute instructions readable on the computer device, wherein the at least one processor is configured to:
provide a conversational information management function to an information provider that desires to provide content to a user of a search service,
conduct a conversation between large language model (LLM)-based artificial intelligence and the information provider through the conversational information management function, and
analyze the conversation and manage a campaign of the information provider.

13. The computer device of claim 12, wherein, to provide the conversational information management function, the at least one processor is configured to provide a function for registering a campaign-specific asset of the information provider through the conversational information management function.

14. The computer device of claim 12, wherein, to conduct the conversation, the at least one processor is configured to create conversation contents to be provided to the information provider using at least two of the campaign of the information provider, a campaign-specific asset of the information provider, a campaign-specific prompt of the information provider, information collected from outside, and contents of the conversation through the artificial intelligence.

15. The computer device of claim 12, wherein, to manage the campaign, the at least one processor is configured to:
create a new campaign using at least one of an asset included in a previously created campaign of the information provider and information collected from outside in relation to the information provider,
modify a prompt of the information provider registered to a previously created campaign of the information provider based on contents of the conversation, or
register a new prompt to a previously created campaign of the information provider based on contents of the conversation.
